(19) United States
(12) Patent Application Publication
(10) Pub. No.: US 2026/0099124 A1
(43) Pub. Date: Apr. 9, 2026

(54) TWO TIME ZONE DEVICE FOR A TIMEPIECE MOVEMENT

(71) Applicant: Matthew D Zinski, Seattle, WA (US)

(72) Inventors: Matthew D Zinski, Seattle, WA (US); Zachary A Smith, Gahanna, OH (US)

(21) Appl. No.: 18/909,142

(22) Filed: Oct. 8, 2024

(51) Int. Cl. G04B 19/23; G04B 19/247

(52) U.S. Cl. CPC G04B 19/235; G04B 19/247

(57) ABSTRACT

A device applied to a mechanical timepiece movement whether it be hand-wound or automatically wound for measuring two time zones using two twelve-hour hands in which a three-position crown is used to wind, jump the date disc in one-day increments, jump the second time zone hour hand forwards or backwards in one-hour increments, and set the time. In particular, the invention proposes a device for synchronizing the time keeping between both twelve-hour hands and allowing the second time zone hour hand to be independently jumped in one-hour increments without affecting the time measured on the other hands from a single time setting device.

### FIELD

The present invention concerns a second time zone mechanism and more particularly such a mechanism comprising of a second hour wheel that measures and displays the second time zone on a fourth hand at a twelve-hour scale, applied to a mechanical timepiece movement whether hand-wound or automatically wound, that can be independently set to a second time zone by a single time-setting device.

The invention concerns the field of mechanical watches, particularly travel time and dual time-type watches.

### BACKGROUND

The era of mass air travel began in the mid-twentieth century, shortly after World War II. This was a time of more people traveling by air than land or water. At this same time watchmakers responded to the needs of both pilots and air travelers with two zone travel watches, particularly four-hand watches showing twelve-hour, sixty-minute, sixty-second, and either a second zone twelve-hour or twenty-four-hour GMT. There is an immediate and lasting difference between how a two zone, two twelve-hour hands watch and a two zone, GMT hand watch is controlled.

Two zone travel watches with two twelve-hour hands were developed with a crown that controls the time setting of all hands while the second twelve-hour hand is independently jumped forward or backward by one hour with an additional pusher or pushers installed on the side of the case. This solution is maintained from the late 1950's right up until its current use in watches today. The advantage of a two-time zone watch with two twelve-hour hands, one being independently adjustable in one hour increments, is intuitive time measurement without requiring secondary measuring scales on the dial or bezel. The disadvantage of the pusher-controlled design is potential vulnerability to a water-resistant case with the additional penetrations.

Twenty four-hour GMT hand watches were developed with a crown that controls the time setting of all hands, initially reliant on bezels to set a reference point for the second time zone. The twenty-four-hour GMT hand watches continued to evolve to allow for independently controlled twelve-hour hand or twenty-four-hour hand through the use of a three-position crown. The advantage of this design is a singular source for controlling the time and hand setting. The disadvantage of this design is its application to twenty-four-hour GMT watches, requiring users to measure time in twelve-hour and twenty-four-hour scales.

A solution is required two zone travel watches that display two twelve-hour hands, both of which are controlled by a three-position crown.

### SUMMARY

The aim of the invention is to provide a device applied to a mechanical timepiece movement whether it be hand-wound or automatically wound for measuring two time zones using two twelve-hour hands in which a three-position crown is used to wind, advance the date disc in one-day increments, jump the second time zone hour hand clockwise in one-hour increments, and set the time. In particular, the invention proposes a device for synchronizing the time keeping between both twelve-hour hands and allowing the second time zone hour hand to be independently jumped in one-hour increments without affecting the time measured on the other hands from a single time setting device.

The invention uses a specific arrangement and design of the minute wheel, hour wheel, second time zone hour wheel, second time zone hour jump spring, second time zone hour jump wheel, second time zone hour corrector wheel, second time zone hour cannon, corrector intermediate setting wheel, corrector setting wheel, and posts applied to a main plate to measure two zones and provide the ability to independently jump the second time zone hour hand.

### BRIEF DESCRIPTION OF DRAWINGS

FIG. 1 is a schematic view of a wristwatch according to the invention, when it is displaying the time for two zones that differ by three hours.

FIG. 2 is a plan view with time setting device in the watch of FIG. 1

FIG. 3 is a schematic axonometric view of the second time zone hour wheel exploded.

FIG. 4 is a schematic axonometric view of the second time zone hour wheel assembled

FIG. 5 is a diagram illustrating the function when the time setting device is in position one

FIG. 6 is a diagram illustrating the function when the time setting device is in position two

FIG. 7 is a diagram illustrating the function when the time setting device is in position three

### DETAILED DESCRIPTION

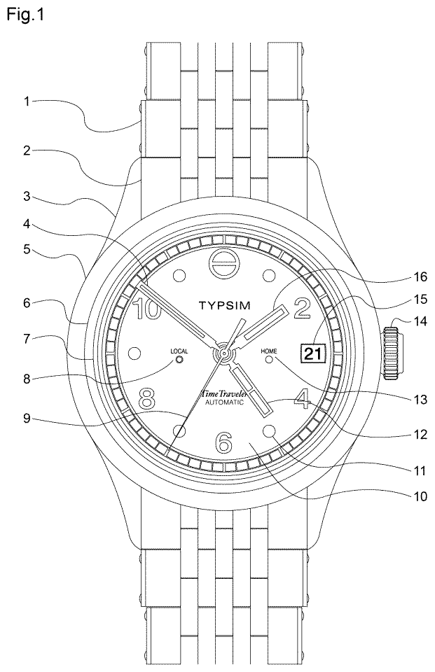

Shown in FIG. 1 is a conventional wristwatch case 3 secured to a bracelet 1 with matching end links 2 which encloses the movement and second time zone mechanism behind a conventional dial 10, crystal 7, and bezel 5. In particular, FIG. 1 illustrates a conventional watch dial 10 layout with hour indexes 11 measured at a 12-hour scale. The instructional decals 8 and 13 are shown for reference only. In particular, this watch illustrates four centrally located hands, a home hour hand 16, a second time zone hour hand 12, a minute hand 4, and a sweep second hand 9. The date disc is show through a date window 15 in the dial at the three o'clock position. The crown 14 is shown as the time setting device.

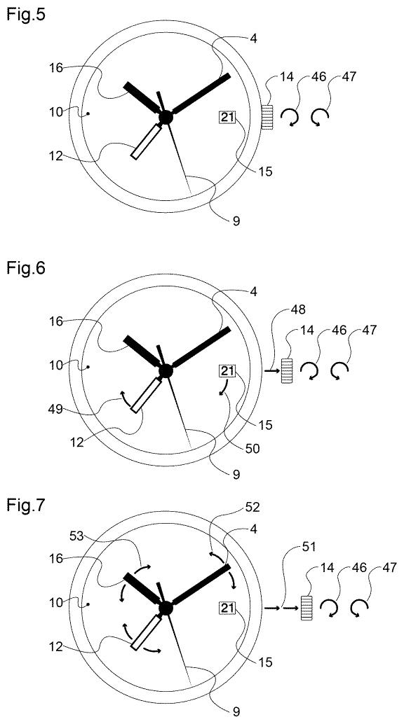

FIG. 1 shows the home time as 1:51:35 on the hour hand 16, minute hand 4, and sweep second hand 9 on the 21^{st} day of the month on the date disc in the date window 15. The second time zone is 4:51:35 shown on the second time zone hour hand 12, minute hand 4, and sweep second hand 9. Both the hour hand 16 and second time zone hour hand 12 measure time at a twelve-hour scale. Unless repositioned, the second time zone hour hand 12 will continue to measure the second time zone constant relative to the hour hand 16. As described in FIG. 5, FIG. 6, and FIG. 7 the time setting device may be used to wind the mechanical movement and adjust the time(s) and date.

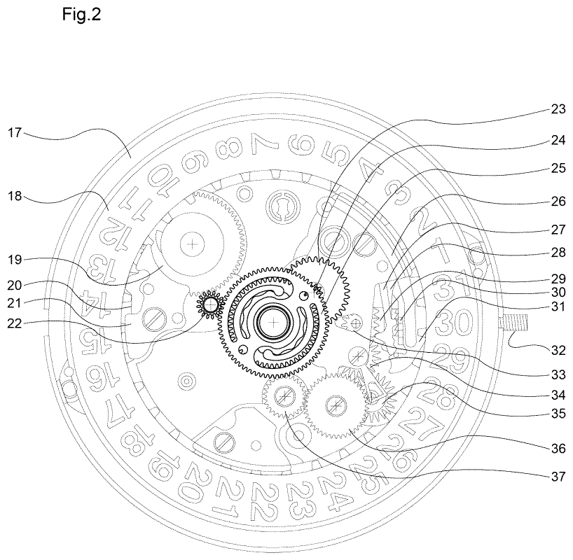

FIG. 2 illustrates the dial side of a 25.60 mm, 11½″, movement 17 with the two-time zone device shown in bold as the intermediate date wheel 22, minute wheel 23, minute pinion 24, and second time zone hour wheel assembly 25.

When the movement is wound and operating to measure time or time setting device 14 connected to the stem 32 is in position three to set the time the minute wheel 23 is driven by the underlying cannon pinion with driving wheel (not shown). The minute wheel 24 is secured to the movement main plate 17 with a long post (not shown). The minute pinion 24 is taller than a standard minute pinion so as to simultaneously drive both the hour wheel (not shown) and second time zone hour wheel assembly 25. The hour wheel (not shown) and second time zone hour wheel assembly 25 both measure time at a twelve-hour scale.

The minute pinion 24 drives the second time zone hour wheel assembly 25 by driving the second time zone hour wheel 41 which is riveted to the second time zone hour jump wheel 40 which is secured to the second time zone hour corrector wheel 38 by the second time zone hour jump spring 39. The second time zone hour corrector wheel 38 is laser welded 44 to the second time zone hour cannon 41.

When the movement is wound and operating to measure time or time setting device 14 connected to the stem 32 is in position three to set the time the second time zone hour wheel 25 drives the intermediate date wheel 22 which in turn drives the base movement date indicator driving wheel 19. The base movement date indicator driving wheel 19 drives the base movement date disc 18 which jumps between dates by the base movement date jumper 20, secured in place by the base movement date indicator maintaining plate 21.

The movement 17 is controlled, wound, quick set date adjustment, quick set second hour hand adjustment, and time setting, by the time setting device 14 connected to the stem 32. The stem 32 controls the base movement 17 from three setting positions, designated by the base movement date corrector operating lever (not shown), setting lever 31, yoke 28, and setting lever jumper 27. The base movement mainspring (not shown) is wound when the time setting device 14 is in position one through the base movement sliding pinion 29 engaged with the winding pinion 30.

When the time setting device 14 is in position two the base movement sliding pinion 29 engages with the setting wheel 33 which engages with the date corrector intermediate setting wheel 34 which engages with the double corrector 35.

Rotating the time setting device 14 clockwise engages the double corrector 35 with the corrector setting wheel 36 and the corrector intermediate wheel 37 which rotates the second time zone hour corrector wheel 38 clockwise. If one more intermediary wheel were introduced the one-hour jumps could move counterclockwise. The rotation is limited to twelve one-hour jumps by the second time zone hour jump wheel 40 which maintains engagement with the second time zone hour jump spring 39.

Rotating the time setting device 14 counterclockwise engages the double corrector 35 with the date disc 18 which rotates clockwise in one-day jumps.

When the time setting device 14 is in position three the base movement sliding pinion 29 engages with the setting wheel 33 which engages with the underlying cannon pinion with driving wheel (not shown) which engages with the minute wheel 23 and minute pinion 24. The minute pinion 24 simultaneously drives both the hour wheel (not shown) and second time zone hour wheel assembly 25. When the time setting device 14 is rotated clockwise the hour wheel, second time zone hour wheel assembly, and cannon pinion rotate counterclockwise. When the time setting device 14 is rotated counterclockwise the hour wheel (not shown), second time zone hour wheel assembly 25, and cannon pinion (not shown) rotate clockwise.

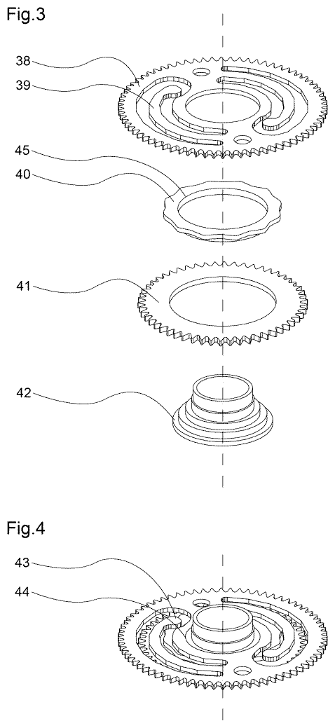

FIG. 3 illustrates separate pieces of the second time zone hour wheel assembly 25 in axonometric view. FIG. 4 illustrates the second time zone hour wheel assembly 25 fully assembled in axonometric view.

The second time zone hour wheel 41 is riveted to the second time zone hour jump wheel 40. This two-piece assembly is positioned on the second time zone hour cannon 42 and allowed to move freely. Lubrication 45 is applied between the second time zone hour jump wheel 40 and the second time zone hour cannon 41.

The second time zone hour corrector wheel 38 is fitted on to the second time zone hour cannon 42 over the two-piece assembly of the second time zone hour wheel 41 and second time zone hour jump wheel 40. The second time zone hour corrector wheel 38 is secured to the second time zone hour corrector wheel 38 by engaging in tension both second time zone hour jump springs 39. Lubrication 43 is applied between the second time zone hour jump wheel 40 and second time zone hour jump springs 39.

The second time zone hour corrector wheel 38 is laser welded 44 to the second time zone hour cannon 42.

The second time zone hour hand 12 is secured to the second time zone hour cannon 42.

FIG. 5, FIG. 6, and FIG. 7 illustrate a diagrammatic watch dial 10 with hour hand 16, second time zone hour hand 12, minute hand 4, sweep second hand 9, date window 15, and time setting device 14.

FIG. 5 illustrates the time setting device 14 in position one, pressed furthest inwards towards the center of the watch dial 10. When the time setting device 14 is rotated in a clockwise direction 46 the movement mainspring is wound. When the time setting device 14 is rotated in a counterclockwise direction 47 the sliding pinion 29 and winding pinion slip 30 resulting in no action to the movement. In this position, when the movement is wound the movement will operate with the hour hand 16, second time zone hour hand 12, minute hand 4, sweep second hand 9, and date window 15 will indicate the time and date. In this diagram, the time is shown as 10:10:25 on the 21^{st}. The second time zone is shown as 7:10:25.

FIG. 6 illustrates the time setting device 14 in position two 48, clicked outwards from the center of the watch dial 10 by one click. When the time setting device 14 is rotated in a clockwise direction 46 the second time zone hour hand jumps clockwise 49 in one-hour increments. When the time setting device 14 is rotated in a counterclockwise direction 47 the date disc jumps clockwise 50 in one-day increments. In this position, when the movement is wound the movement will operate with the hour hand 16, second time zone hour hand 12, minute hand 4, sweep second hand 9, and date window 15 will indicate the time and date. In this diagram, the time is shown as 10:10:25 on the 21^{st}. The second time zone is shown as 7:10:25.

FIG. 7 illustrates the time setting device 14 in position three 51, clicked outwards from the center of the watch dial 10 by two clicks. When the time setting device 14 is rotated in a clockwise direction 46 the hour hand 16, second time zone hour hand 12, and minute hand 4 rotate counterclockwise 52. When the time setting device 14 is rotated in a counterclockwise direction 47 the hour hand 16, second time zone hour hand 12, and minute hand 4 rotate clockwise 53. The hour hand 16 and second hour hand 12 will maintain a constant relationship as the time is set. The date 15 will advance forward one day for every two-full, twelve-hour clockwise rotations the hands are advanced. In this position, when the movement is wound the movement is hacked and will not. In this diagram, the time is shown as 10:10:25 on the 21^{st}. The second time zone is shown as 7:10:25.

1. A device added to a mechanical timepiece movement be it hand-wound or automatically winding that provides a fourth hand measuring a second time zone at a twelve-hour scale that may be, independent of the other time measuring hands, jumped clockwise or counterclockwise in one-hour increments.

2. The device as claimed in claim 1, wherein the time setting device must be positioned in the second setting position.

3. The device claimed in claim 2, wherein the time setting device rotates clockwise to jump the second time zone hour hand clockwise, or with an added intermediate wheel jump the second time zone hour hand counterclockwise, in one-hour increments and counterclockwise to advance the date disc in one-day increments.

4. The device as claimed in claim 1, wherein the hour wheel and second time zone hour wheel are driven by the minute wheel.

5. The device as claimed in claim 1, wherein the second time zone hour wheel is an assembly of a multi-step cannon, an hour wheel driven by the minute wheel, an hour jump wheel riveted to the hour wheel and fit around second largest radius of the cannon, and an hour corrector wheel laser welded to the third largest radius of the cannon and set into tension with the hour jump wheel.

6. The device as claimed in claim 5, wherein the hour corrector wheel is cut with two opposing spring arms that align to the twelve teeth of the hour jump wheel.

7. The device as claimed in claim 6, wherein the spring arms lock into tensions between the teeth of the hour jump wheel.

8. The device as claimed in claim 7, wherein the spring arms provide adequate tension to rotate with the hour wheel without slipping out of place maintaining consistent alignment with hour wheel when set.

9. The device as claimed in claim 8, wherein the tensions of the spring arms may be overcome by rotating the hour corrector wheel by the corrector setting wheel rotated by the corrector intermediate setting wheel rotated by the double corrector rotated by the setting wheel rotated by the sliding pinion rotated by the stem rotated by the crown clockwise.

10. The device as claimed in claim 1, wherein the second time zone hour wheel assembly is fitted around the hour wheel.

11. The device as claimed in claim 1, wherein the minute wheel pinion is of a height to drive both the hour wheel and second time zone hour wheel.

12. The device as claimed in claim 11, wherein the minute wheel post is of a height to support the height of the minute wheel pinion completely.

13. The device as claimed in claim 1, wherein the time is measured by up to four but no less than two centrally located hands of any design.

14. The device as claimed in claim 13, wherein the four hands measure seconds, minutes, zone one hours, and zone two hours.

15. The device as claimed in claim 2, wherein the time setting device rotates clockwise to jump the second time zone hour hand clockwise, or with an added intermediate wheel jump the second time zone hour hand counterclockwise, in one-hour increments and, if the double corrector wheel is replaced with a corrector wheel, counterclockwise to jump the second time zone hour hand counterclockwise, or with an added intermediate wheel jump the second time zone hour hand clockwise, in one-hour increments.

16. The device as claimed in claim 15, wherein the date disc is advanced only through position three of the time setting device, advancing the time forward one day at a time.
